(19) United States
(12) Patent Application Publication
(10) Pub. No.: US 2024/0170021 A1
(43) Pub. Date: May 23, 2024

(54) LIVE MOBILE VIDEO CAPTURE FROM MULTIPLE SOURCES

(71) Applicant: BOBROUD HOLDINGS, LLC., Clayton, NC (US)

(72) Inventor: Boris Issavi, Clayton, NC (US)

(73) Assignee: BOBROUD HOLDINGS, LLC., Clayton, NC (US)

(21) Appl. No.: 18/057,820

(22) Filed: Nov. 22, 2022

(51) Int. Cl. G11B 27/031; H04N 5/77

(52) U.S. Cl. CPC G11B 27/031; H04N 5/77

(57) ABSTRACT

A method and software capable of creating a single video from multiple videos provided by non-related mobile devices that record videos at the same event, wherein there is a designated event host participant who selects additional event participants within the same event who record from their vantage point.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

### Field of the Invention

The present invention relates to a method and software for taking multiple recordings from multiple mobile devices at the same event. More particularly, it relates to a system that takes multiple live videos at the same event from multiple mobile devices such as cell phones, tablets, and the like, time stamps them, and combines them into a single edited video utilizing the live videos.

### Description of Related Art

The use of mobile devices, such as cell phones and tablets that record video in high definition has been growing with each new generation of devices. Accordingly, social media is awash with individual videos on relatively anything that can be videoed. It is not unusual for several videos of an event, such as a sporting event, concert, or the like, to be available to the public through different platforms. This gives a viewer several different angles and content. However, it means that a viewer must watch each of the videos, which are likely on several different platforms, to see different angles and different content.

Large video production companies, like TV networks, and the like, utilize several connected cameras at events, allowing an editor who has access to each camera to be able to switch between different views/angles during a live broadcast. This works because all of the connected cameras are owned by the video production company or the cameras are prearranged to work through the video production company at a remote location, and not directly at the event.

Individuals who have non-related mobile devices do not have the ability to shoot videos simultaneously at the same event that can be utilized as a live feed, nor are they able to record an event from multiple angles.

### BRIEF SUMMARY OF THE INVENTION

Accordingly, in one embodiment, there is a method of creating a single video taken with multiple video-enabled, non-related mobile devices at the same event comprising:
a) using a video coordinating mobile device application on an event host participant's mobile device to create a same event host participant for the same event, the event host participant having a mobile device with the video coordinating mobile device application;
b) a plurality of additional event participants at the same event each having a mobile device, are selected by the same event host participant using the video coordinating mobile device application which sends an invitation to additional event participants inviting the selected additional event participants to participate, wherein each of the plurality of additional event participants has the video coordinating mobile device application on the additional event participants' mobile devices;
c) the event host participant and the additional event participants each video recording the same event using the video coordinating mobile device application on each of their mobile devices to create a video of the event;
d) the additional event participants' videos are transferred to the event host participant's mobile device, wherein each additional event participants' video is time-coded with the event host participant's video using the video coordinating mobile device application; and
e) wherein the event host participant edits the event host participant video and the additional event participants' videos into a single video of the same event.

In another embodiment, there is a non-transitory computer-readable storage medium embodying instruction that, when executed by a processing device on a mobile device, causes the mobile device to perform a mobile device implemented method of time coding and editing of multiple videos of the same event using a plurality of event participants' video recordings from each of the event participants' mobile devices, comprising:
a) an instruction to designate an event host participant mobile device and event host participant user;
b) an instruction to designate a plurality of additional event participants' mobile devices operated by a plurality of additional event participants;
c) capture of videos from each of the additional event participant's recording of the same event wherein each of the captured videos are time-coded; and
d) editing of the multiple videos into a single video by the event host participant.

### BRIEF DESCRIPTION OF THE DRAWINGS

FIG. 1 is a graphic representation of the relationship and activities of the different parts of the present invention.

FIG. 2 is a flow chart of the method of the present invention.

FIG. 3 is a flow chart of the activities of a non-transitory computer-readable storage medium of the present invention.

### DETAILED DESCRIPTION OF THE INVENTION

While this invention is susceptible to embodiment in many different forms, there is shown in the drawings, and will herein be described in detail, specific embodiments with the understanding that the present disclosure of such embodiments is to be considered as an example of the principles and not intended to limit the invention to the specific embodiments shown and described. In the description below, like reference numerals are used to describe the same, similar, or corresponding parts in the several views of the drawings. This detailed description defines the meaning of the terms used herein and specifically describes embodiments in order for those skilled in the art to practice the invention.

### Definitions

The terms “about” and “essentially” mean±10 percent.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

The term “comprising” is not intended to limit inventions to only claiming the present invention with such comprising language. Any invention using the term comprising could be separated into one or more claims using “consisting” or “consisting of” claim language and is so intended.

Reference throughout this document to “one embodiment”, “certain embodiments”, “an embodiment”, or similar terms means that a particular feature, structure, or characteristic described in connection with the embodiment is included in at least one embodiment of the present invention. Thus, the appearances of such phrases in various places throughout this specification are not necessarily all referring to the same embodiment. Furthermore, the particular features, structures, or characteristics may be combined in any suitable manner in one or more embodiments without limitation.

The term “or”, as used herein, is to be interpreted as an inclusive or meaning any one or any combination. Therefore, “A, B, or C” means any of the following: “A; B; C; A and B; A and C; B and C; A, B, and C”. An exception to this definition will occur only when a combination of elements, functions, steps, or acts are in some way inherently mutually exclusive.

The drawings featured in the figures are for the purpose of illustrating certain convenient embodiments of the present invention and are not to be considered as limitation thereto. The term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein, and use of the term “means” is not intended to be limiting.

As used herein, the term “multiple non-related mobile devices” refers to any of a variety of electronic devices such as a mobile telephone, personal digital assistant (PDA), tablet computing device, laptop personal computer, or other devices, wherein each mobile device is owned or controlled by a single independent user. Each mobile device used is designed to be portable and able to communicate on a wireless network such as a cellular telecommunications network, Wi-Fi, Bluetooth®, or other such wireless network.

As used herein, the term “same event” refers to an event attended by a large number of people at one time. Examples include entertainment events such as, a concert, sports events (e.g., a baseball game), business events, and the like.

As used herein, the term “video coordinating mobile device application” refers to a non-transitory computer (mobile device) storage medium embodying instruction that, when executed by a processing device on a mobile device, causes the mobile device to implement designating an event host participant, designating additional event participants, recording events on the mobile device, time coordinating multiple videos from separate sources, and editing a plurality of time-coded videos.

As used herein, the term “same event host” refers to an individual, or the like, with a mobile device that will coordinate, edit, and choose additional event participants for participation in recording the same event. The mobile device application will designate who the event host is, and at the event host's instruction, the application will invite additional individual event participants.

As used herein, the term “host mobile device” refers to a mobile device used by the event host where videos are edited after collection and time-coded with each of the event participant's videos.

As used herein, the term “additional event participants” refers to individuals independent of one another who each have their own mobile device for recording the same event. In one embodiment, multiple additional event participants would each video record the same event from different angles and perspectives. The additional event participant downloads the event info and records a proprietary timecode associated with the recording.

As used herein, the term “invitation” refers to the mobile device application sending out invitations from the event host participant to each individual additional event participant, wherein each individual sent an invitation will independently record the event.

As used herein, the term “record the same event” refers to both the event host participant and the additional event participants individually recording videos at the same event. For example, multiple people taking videos at the same concert from their seats or vantage points.

As used herein, the term “create a single video” refers to both the event host participant and the additional event participants recording the same designated event utilizing each event participant's individual mobile device, wherein each event participant is using a video coordinating mobile device application, and the event host participant's mobile device collecting the videos from the additional event participants, utilizing a network such as Wi-Fi, Bluetooth®, internet, and the like, to create a single video of the same event.

As used herein, the term “edit” refers to taking multiple copies of the same recorded event from each event participant and editing them together into a single video.

As used herein, the term “non-transitory computer-readable storage medium” refers to the storage of computer program codes comprising instructions executable by at least one processor for adaptively controlling and executing the recording, announcing, editing, and other aspects of the system described herein.

As used herein, the term “instruction” refers to input from a user to have the software implement directions for the system.

As used herein, the term “processing device” refers to a device or combination of devices having circuitry used for implementing the communication and/or logic functions of a particular system. For example, a processing device may include a digital signal processor device, such as a microprocessor.

As used herein, the term “time-coded” refers to a sequence of numeric codes generated at regular intervals using a time synchronization system. In one embodiment, it refers to the ability of the computer's program codes to take each of the collected videos of the same event and time code them against each other so that edits are possible without time errors.

### DRAWINGS

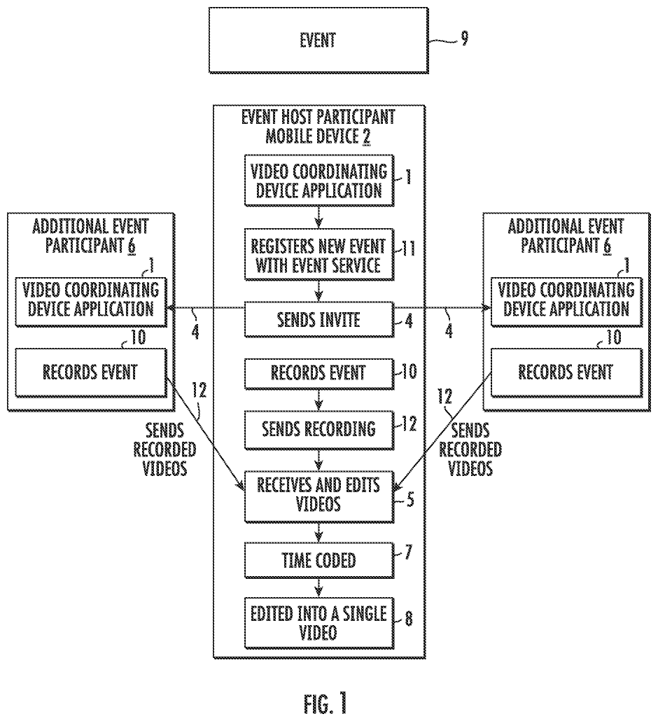

Now referring to the drawings, FIG. 1 is a relationship chart of the parts of the present invention. The recording system for the present invention starts with a video coordinating device application 1 on an event host participant mobile device 2. The video coordinating device application 1 contains a non-transitory computer readable storage medium embodying instructions including designating an event host participant mobile device 2, and registers new event with event service 11. Event host participant mobile device 2 sends invitations 4 to additional event participants 6. One or more additional event participants 6 each have the video coordinating device application 1 on their phone; however, this version does not need any functionality other than being used to record 10 an event 9, and send the recording to event host participant mobile device 2 video coordinating device application 1, wherein the videos are received and edited 5. Event host participant mobile device 2 and additional event participants 6 take event recording 10 and send the video recording 12 to the video coordinating device application 1 on event host participant mobile device 2. The videos are received and edited 5 on event host participant's mobile device 2. The video coordinating device application 1 can then be used by the event host participant's mobile device 2, wherein all the videos are time-coded 7 with one other and the multiple videos received by the event host participant mobile device 2 and the additional event participants 6 are edited into a single video 8

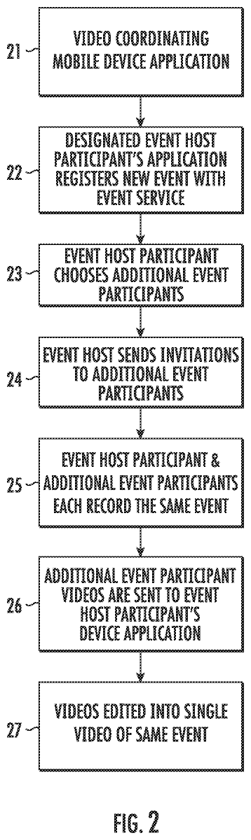

FIG. 2 is a flow diagram of the present invention. A video coordinating mobile device application 21 is utilized to designate an event host participant's application to register a new event with event service 22 on event host participant's mobile device. Next, the designated event host participant chooses additional event participants 23 and the video coordinating mobile device application 21 subsequently sends invitations to additional event participants 24 and the additional event participants 23. Next, the event host participant and the additional event participants each record the same event 25. Then event host participant and additional event participants each send their recorded videos 26 to the video coordinating mobile device application 21 on event host participant's mobile device where they are time-coded. The event host participant can use the time-coded videos to edit them into a single video 27.

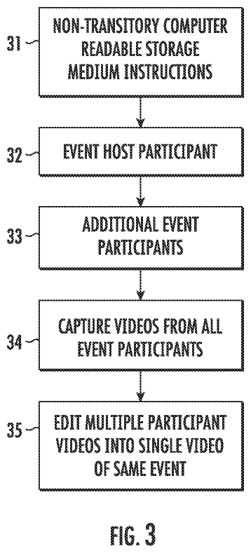

FIG. 3 is a flow chart of how the video coordinating mobile device application directs the method. A non-transitory computer-readable storage medium with instructions 31 designates an event host participant 32. The event host participant 32 chooses additional event participants 33 and the instructions 31 operate to send invitations to the additional event participants 33 that are designated. All event participants then record the same event from each of their vantage points 34 (e.g., vantage point differences due to seating location, perspective angles, and the like), which is sent to the event host participant's non-transitory computer-readable storage medium programmed with instructions 31. Lastly, the instructions 31 allow the event host participant to edit the collection of the event host participant's video, along with the multiple videos received from the additional event participants into a single video 35.

Those skilled in the art to which the present invention pertains may make modifications resulting in other embodiments employing principles of the present invention without departing from its spirit or characteristics, particularly upon considering the foregoing teachings. Accordingly, the described embodiments are to be considered in all respects only as illustrative, and not restrictive, and the scope of the present invention is, therefore, indicated by the appended claims rather than by the foregoing description or drawings. Consequently, while the present invention has been described with reference to particular embodiments, modifications of structure, sequence, materials, and the like apparent to those skilled in the art still fall within the scope of the invention as claimed by the applicant.

What is claimed is:

1. A method of creating a single video taken with multiple video-enabled, non-related mobile devices at a same event comprising:
a) using a video coordinating mobile device application on an event host participant's mobile device to create a same event host participant for the same event, the event host participant having a mobile device with the video coordinating mobile device application;
b) a plurality of additional event participants at the same event each having a mobile device, are selected by the same event host participant using the video coordinating mobile device application which sends an invitation to additional event participants inviting the selected additional event participants to participate, wherein each of the plurality of additional event participants has the video coordinating mobile device application on the additional event participants' mobile devices;
c) the event host participant and the additional event participants each video recording the same event using the video coordinating mobile device application on each of their mobile devices to create a video of the event;
d) the additional event participants' videos are transferred to the event host participant's mobile device, wherein each additional event participants' video is time-coded with the event host participant's video using the video coordinating mobile device application; and
e) wherein the event host participant edits the event host participant video and the additional event participants' videos into a single video of the same event.

2. A non-transitory computer-readable storage medium embodying instruction that, when executed by a processing device on a mobile device, causes the mobile device to perform a mobile device implemented method of time coordinating and editing of multiple videos of the same event using a plurality of event participants' video recordings from each of the event participants' mobile devices, comprising:
a) an instruction to designate an event host participant mobile device and event host participant user;
b) an instruction to designate a plurality of additional event participants' mobile devices operated by a plurality of event participants;
c) capture of videos from each of the additional event participant's recording of the same event wherein each of the captured videos are time-coded; and
d) editing of the multiple videos into a single video by the event host participant.
